(19) United States
(12) Patent Application Publication
(10) Pub. No.: US 2006/0276295 A1
(43) Pub. Date: Dec. 7, 2006

(54) Transmission for a motor vehicle with continuously variable power-split drive ranges

(75) Inventor: Carsten Gitt, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/431,669

(22) Filed: May 11, 2006

(30) Foreign Application Priority Data
May 12, 2005 (DE) 10 2005 022 012.6

(51) Int. Cl. F16H 37/02

(52) U.S. Cl. 475/210

(57) ABSTRACT

A transmission, for example for a commercial motor vehicle, has continuously variable drive ranges, with a power branch, and a direct gear. In contrast to known transmissions, in which power branches are combined via pairs of gearwheels, two power paths are combined via a planet set. The planet set can be used multi-functionally, since the latter, in addition to combining the power paths in a power-split drive range, is also used as a range group in a drive range with no power split. In addition, a change between continuously variable power-split drive ranges is possible at a synchronous point.

This application claims the priority of German application 10 2005 022 012.6, filed May 12, 2005, the disclosure of which is expressly incorporated by reference herein.

### BACKGROUND AND SUMMARY OF THE INVENTION

This invention relates to a transmission for a motor vehicle with at least two continuously variable power-split drive ranges.

German publication DE 43 08 761 A1 discloses a transmission for a motor vehicle which has two power-split continuously variable forward drive ranges. In this transmission, via an input-side planet set, a power split takes place between a power path which forms a direct gear and a second power path which, with step-up stages interposed, runs via a variator. The power branches are combined via gearwheels which are drive-connected to the continuously variable power path and are connectable via shift elements to the transmission elements of the power path forming the direct gear. For the different drive ranges, the power flow for this known transmission is reversed via the variator, so that the driving-disc set of the variator in one drive range serves in the other drive range as a driven-disc set. As a result of a continuously variable design of the transmission in an i²-arrangement, step-up spreads of 15 are to be achieved. In a transmission of this type, under some circumstances, an additional torque converter may be superfluous. Furthermore, the transmission is to allow a low fuel consumption, a good acceleration behavior and a relatively small-build variator at acceptable production costs and with good efficiency. A changeover between the drive ranges can take place at a synchronous rotational speed, which is to result in a good shift quality and low shift work.

Applicant's German publication DE 102 47 174 A1 discloses a further transmission in which there are continuously variable drive ranges for which the power flow is reversed via the variator in the case of a change from one drive range to another drive range.

Further transmission concepts are known from international, German, and European publications WO 2004/040171 A1, DE 102 05 752 A1, DE 102 02 754 A1, EP 0 105 515 A1, EP 0 347 186 B1, and EP 0 210 053 A2, and from U.S. Pat. documents 4,885,955 and 9,388,949.

One object on which the present invention is based is to propose a transmission with at least one continuously variable drive range. The transmission is improved in terms of the possibilities of use and the diversity of the transmission stages. Particular importance is given to the construction-space conditions, the multiplicity of transmission elements employed, the spread, the efficiency, and/or the possibilities of use for a commercial vehicle.

The object mentioned is achieved by way of a transmission for a motor vehicle with at least two continuously variable drive ranges, in which a power split to two power paths takes place, including gear wheels, a variator, and a planet set, and in which, in one power path, power transmission via pairs of the gearwheels or directly takes place, while, in the other power path, power transmission takes place via the variator which allows a continuous change of step-up. The two power paths can be combined via the planet set, and at least one further continuously variable drive range is provided, in which no power split takes place and in which the planet set is used as a range group. A change from one power-split drive range to another power-split drive range takes place at a synchronous point. Further refinements of the invention are reflected in the claims.

In the transmission according to the invention, a power split to two power paths takes place in two power-split drive ranges. This measure has the fundamental advantage that only a fraction of the power is transmitted in the individual power paths, as a result of which there can be a reduced design of the transmission elements involved in the power paths and/or a transmission of higher powers by the transmission can take place in the power-split drive ranges. Likewise, owing to the power split and the subsequent combining of the power paths, a wide range of implementable step-ups can be made available for the design and/or operating ranges of the transmission.

In one power path, power transmission takes place via pairs of gearwheels or a direct gear. When a direct gear is used, a rigid transmission of power takes place, without rolling connections being interposed, with the result that power losses are also avoided, so that a high efficiency of the transmission is achieved. In the other power path, power transmission takes place via a variator which may be designed as a wrap-around variator or as a toroidal variator. The variator allows a continuous change of step-up in the assigned power path, with the result that the overall step-up of the transmission is also continuously variable as a result of the superposition of the two power paths. The maximum power transmittable by a variator is limited, is correlated with its overall size and constitutes a critical variable. According to the invention, use can be made of the fact that the variator is not exposed to the entire power flow, but is acted upon only by a part-power. A continuously variable transmission can thereby also be used for power ranges in which transmissions where the entire power runs via the variator could not be used.

In the solution according to the invention, the combining of the two power paths takes place via a planet set (or a triple-shaft subassembly), in which one transmission element is drive-connected to one power path, a further transmission element is drive-connected to the other power path and, with the two power paths being combined, the third transmission element is drive-connected to a transmission output shaft. By the planet set being used for combining, it is possible, in contrast to combining via a simple gearwheel pairing in which the two power paths are connected to a gearwheel, for the rotational speed of the driven element of the planet set to deviate from the rotational speed of the transmission elements of the planet set which are assigned to the respective power paths.

As compared with the transmission known from German publication DE 43 08 761 A1, the number of operating possibilities and of the step-up stages and ranges achievable can be increased in that a further drive range in which no power split takes place is provided.

According to the invention, even in the drive range with no power split, a power flow takes place via the planet set, so that the latter is used multi-functionally. However, in the drive range with no power split, the planet set is not used as a superposition transmission, but, instead, as a range group. This means that, independently of the drive movement, one transmission element of the three transmission elements of the planet set is placed into a defined drive state. In the simplest instance, to bring about a defined drive state of a transmission element, the latter is braked with respect to the housing of the transmission via a brake. In this case, it is particularly advantageous if the remaining non-braked transmission elements can be selectively connected to different power flows with no power split via suitable operative connections. According to the invention, an increase or multiplication of the drive connections achievable takes place, whilst individual transmission elements, such as pairs of gearwheels, can be used multi-functionally both in power-split drive ranges and for the discrete gear stages.

Corresponding to a further feature according to the invention, the change from one power-split drive range to another power-split drive range takes place at a synchronous point. A result of this is that, for a change of the drive range, no differential rotational speed has to be bridged, or only a differential rotational speed which is low in terms of actuation accuracy, with the result that a rapid change of the drive range is possible, shift elements involved can be protected and improved driving comfort is obtained. Furthermore, a reduced outlay in terms of regulation and of actuation arises if step-up of the variator does not have to be adjusted during a change of the drive range.

According to a further refinement of the invention, in the event of a change from a first continuously variable drive range to a second continuously variable drive range, the power flow changes its direction via the variator. As a result, a disc set which represents the input side of the variator in the first operating range becomes the driven-disc set in the second operating range (and vice versa). The output side of the variator in the first power-split drive range can thereby be assigned to a different transmission element of the planet set from that in the second power-split drive range, with the result that different step-up ratios on the output-side planet set can be obtained.

According to a particular refinement of the transmission according to the invention, the latter has a control device. The control device varies the variator step-up in time proximity to a change between the drive ranges. Synchronization and/or adaptation of an angular position in the region of a shift element to be actuated thereby take place. This results in a multi-functional utilization of the variator, since the latter serves not only for a continuous change of step-up, but additionally as a “synchronization element”. A required synchronization in the region of the shift element may be dispensed with or undergoes reduced action, thus resulting in lower dimensioning and/or a longer useful life.

Particularly in connection with a commercial vehicle, according to a further proposal of the invention, a reshift transmission is additionally provided. A particularly favorable efficiency of the transmission, including the reshift transmission, may be achieved if a direct gear is also provided in the reshift transmission.

Advantageous developments become apparent from the subclaims, the description and the drawings. Further features may be gathered from the drawing, in particular the illustrated geometries of the components, the relative dimensions of a plurality of illustrated measures of identical or different components, the arrangement of the components in relation to one another and their operative connections to one another. The combination of features of different embodiments illustrated in various figures, features of different claims and/or the abovementioned features with features of the embodiments of the prior art mentioned is likewise possible and is hereby suggested. Further features of the invention may be gathered from the illustrated wheel plans, these features relating particularly to the selected drive connections and rigid connections of the diagrammatically illustrated transmission elements, to the arrangement of the wheel planes, to the size ratios of the illustrated transmission elements and to the step-up ratios resulting from these.

Preferred exemplary embodiments of the transmission according to the invention are explained in more detail below with reference to the drawing figures.

### BRIEF DESCRIPTION OF THE DRAWINGS

FIG. 1 shows a wheel plan of a first embodiment according to the invention of a transmission,

FIG. 2 shows the transmission according to FIG. 1 in a first drive range with no power split, in which an output-side planet set is used as a range group,

FIG. 3 shows the transmission according to FIG. 1 in a first power-split drive range, in which the output-side planet set is used for combining the power paths,

FIG. 4 shows the transmission according to FIG. 1 in a second power-split drive range, in which the output-side planet set is used for combining the power paths,

FIG. 5 shows a wheel plan of a further embodiment according to the invention of a transmission,

FIG. 6 shows the transmission according to FIG. 5 in a drive range with no power split, in which an output-side planet set is used as a range group,

FIG. 7 shows a wheel plan of a further embodiment according to the invention of a transmission, and

FIG. 8 shows the transmission according to FIG. 7 in a drive range with no power split, in which an output-side planet set is used as a range group.

### DETAILED DESCRIPTION OF THE INVENTION

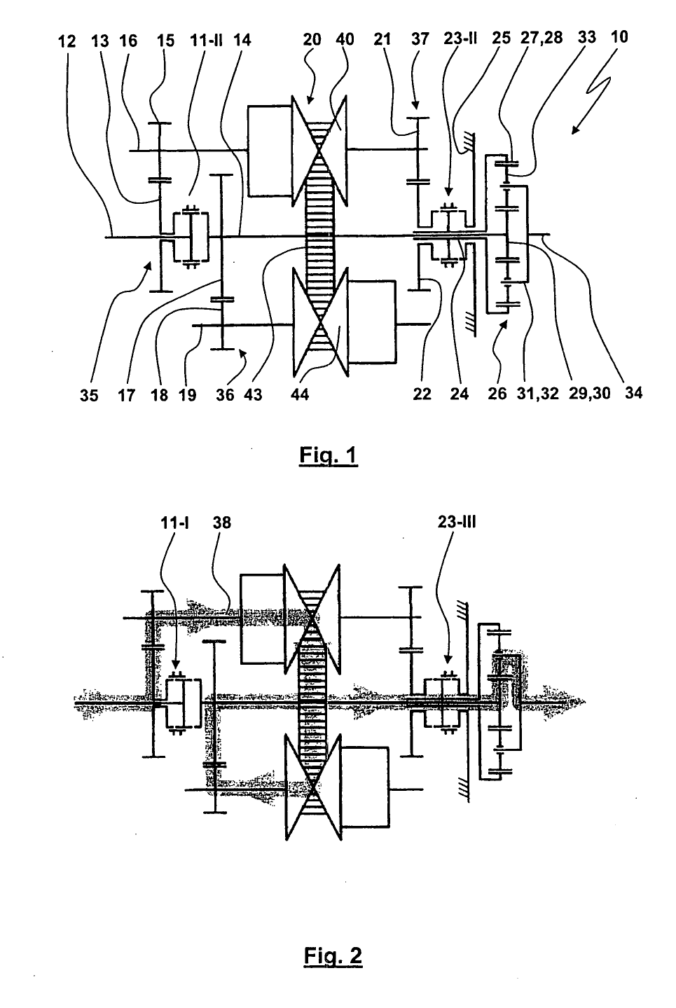

FIG. 1 shows a transmission 10, in which, via a shift element 11, a transmission input shaft 12 can be coupled to a driving gearwheel 13 in a left-hand shift position 11-I, can be coupled to a main shaft 14 in a right-hand shift position 11-III, and is decoupled from the driving gearwheel 13 and the main shaft in the middle shift position 11-II.

The driving gearwheel 13 meshes with a driven gearwheel 15 which is connected, fixedly in terms of drive, to a secondary shaft 16. Tied up fixedly in terms of rotation to the main shaft 14, adjacently to the shift element 11, is a driving gearwheel 17 meshing with a driven gearwheel 18 which, in turn, is connected fixedly in terms of rotation to a secondary shaft 19. The secondary shafts 16, 19 are drive-connected to one another via a continuously variable wrap-around variator 20. On that side of the wrap-around variator 20 which faces away from the driven gearwheel 15, a driving gearwheel 21, which meshes with a driven gearwheel 22, is connected fixedly in terms of rotation to the secondary shaft 19.

A shift element 23 connects the driven gearwheel 22 to a hollow shaft 24 in the left-hand shift position 23-I, is inactive in the middle position 23-II, and connects the hollow shaft 24 to the housing 25 in a right-hand shift position 23-III.

The transmission 10 has a planet set 26 on the output side. A first transmission element 27, here a ring wheel 28, of the planet set 26 is drive-connected to the hollow shaft 24. A further transmission element 29, here a sun wheel 30, of the planet set 26 is drive-connected to the main shaft 14. A further transmission element 31, here a web 32, with respect to which planets 33 are mounted rotatably, is drive-connected to a transmission output shaft 34.

The gearwheels 13, 15 form a step-up stage 35, the gearwheels 17, 18 a step-up stage 36 and the gearwheels 21, 22 a step-up stage 37. The step-up stage 35, with a step-up stage 36, the wrap-around variator 20, the step-up stage 37 and the planet set 26 are arranged one behind the other, in parallel wheel planes, in this order from the input side of the transmission 10 to the output side.

FIG. 2 shows the transmission 13 according to FIG. 1 for a drive range with no power split, in which the shift element 11 is in shift-position 11-I and the shift element 23 is in shift position 23-III. In a power path 38 with no power split, a power flow takes place from the transmission input shaft 12 via the shift element 11, driving gearwheel 13, driven gearwheel 15, secondary shaft 16, variator 20, secondary shaft 19, driven gearwheel 18, driving gearwheel 17 and main shaft 14 to the sun wheel 30 driving the planet 33 which is braked radially on the outside to a speed of zero, since the ring wheel 28 is braked with respect to the housing 25 via the shift element 23. The web 32 drives the transmission output shaft 34.

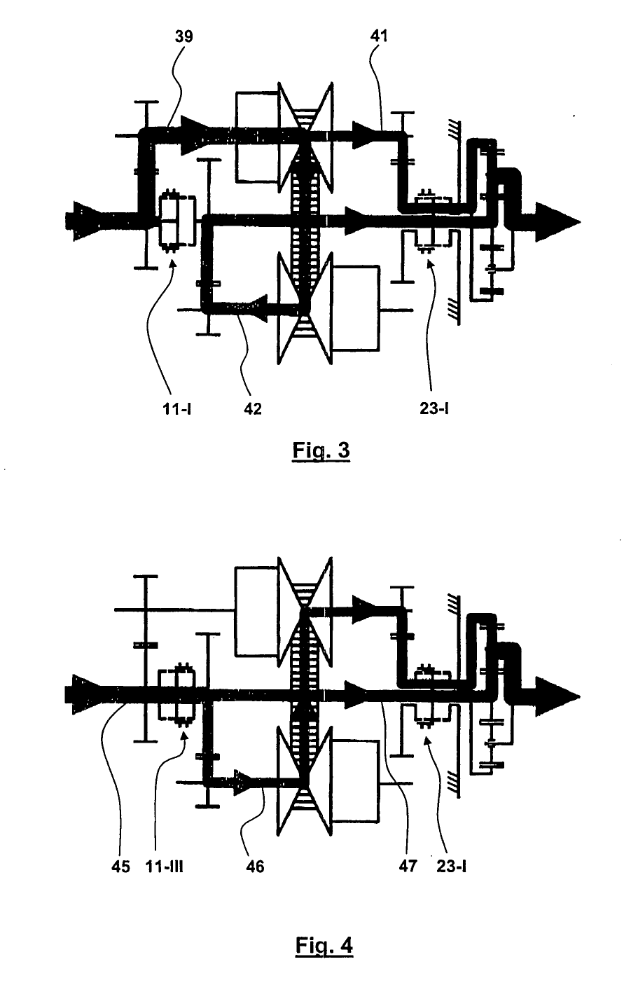

FIG. 3 shows the transmission 13 according to FIG. 1 for a first power-split drive range, in which the shift element 11 is in shift position 11-I and the shift element 23 is in shift position 23-I. The power runs first via a common power path 39 which runs via the transmission input shaft 12, shift element 11, driving gearwheel 13, driven gearwheel 15 and secondary shaft 16 to a first disc set 40 of the wrap-around variator 20. The power is split here to two power paths 41, 42. The power path 41 runs via the secondary shaft 16, driving gearwheel 21, driven gearwheel 22, shift element 23 and hollow shaft 24 to the ring wheel 28. The power path 42 runs via a wrap-around means 43 of the wrap-around variator 20, a further disc set 44 of the wrap-around variator 20, secondary shaft 19, driven gearwheel 18, driving gearwheel 17 and main shaft 14 to the sun wheel 30. In the planet set 26, a superposition of the power paths 41, 42 by means of the planet 33 to the web 32 and consequently to the transmission output shaft 34 takes place.

FIG. 4 shows the transmission 13 according to FIG. 1 for a further power-split drive range, in which the shift element 11 is in shift position 11-III and the shift element 23 is in shift position 23-I. A common power path 45 runs first via the transmission input shaft to the shift element 11. In the region of the shift element 11, the power path 45 is split into two power paths 46, 47. The power path 46 runs from the shift element 11 via the driving gearwheel 17, driven gearwheel 18, secondary shaft 19, disc set 44, wrap-around means 43, disc set 40, secondary shaft 16, driving gearwheel 21, driven gearwheel 22, shift element 23 and hollow shaft 24 to the ring wheel 28. The power path 47 runs from the shift element 11 via the main shaft 14 to the sun wheel 30. In the planet set 26, a superposition of the power paths 46, 47 to the web 32 and consequently to the transmission output shaft 34 takes place by means of the planet 43.

In the event that the shift element 11 is in shift position 11-III, a direct drive of the sun wheel 30 takes place, without meshing transmission members being interposed. Should the shift element 23 be in shift position 23-III, a wrap-around variator 20 is not inserted into the power flow. Instead, for the stationary ring wheel 28, a drive takes place from the sun wheel 30 via the planets 33 to the web 32 and consequently to the transmission output shaft 34.

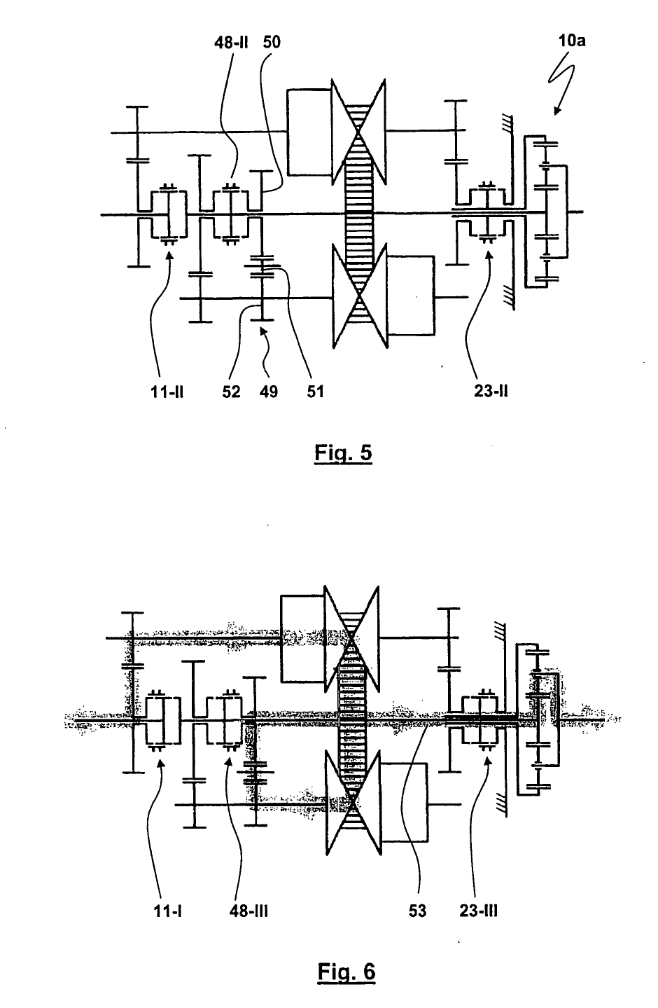

FIG. 5 shows a transmission 10a which, with the exception of the following changes, corresponds essentially to the transmission 10 according to FIG. 1 and for which the drive ranges illustrated in FIGS. 2 to 4 are basically possible. Contrary to the transmission 10, for the transmission 10a, the driving gearwheel 17 is not directly connected fixedly in terms of rotation to the main shaft 14, but is connectable fixedly in terms of rotation to the main shaft 14 via a shift element 48 in a left-hand shift position 48-I. In a further wheel plane lying between the step-up stage 36 and the wrap-around variator 20, a reverse-gear step-up stage 49 is arranged, by which the driving gearwheel 50 is connected fixedly in terms of rotation to the main shaft 40 via a shift element 48 in shift position 48-III. In the middle shift position 48-II, the main shaft 14 is not connected either to the driving gearwheel 17 or to the driving gearwheel 50. The driving gearwheel meshes with a reverse-gear wheel 51 driving a driven gearwheel 52 which is connected fixedly in terms of rotation to the secondary shaft 19. With the shift element 48 in shift position 48-I, the transmission 10a makes it possible to have all the drive possibilities of the transmission 10.

Furthermore, FIG. 6 shows a continuously variable reverse drive range with no power split, which is activated by means of the shift element 48 in shift position 48-III. In this case, the power path 53 runs via the transmission input shaft 12, shift element 11, driving gearwheel 13, driven gearwheel 15, secondary shaft 16, disc set 40, wrap-around means 43, disc set 44, secondary shaft 19, driven gearwheel 52, reverse-gear wheel 51, driving gearwheel 50, shift element 48, main shaft 14 and sun wheel 30, with the ring wheel 28 braked with respect to the housing 25, to the web 32 and consequently to the transmission output shaft 34. The power flow thus corresponds essentially to the power flow according to FIG. 2, the power path 53 not running via the step-up stage 36 (forward gear), but, instead, via the reverse-gear step-up stage 49.

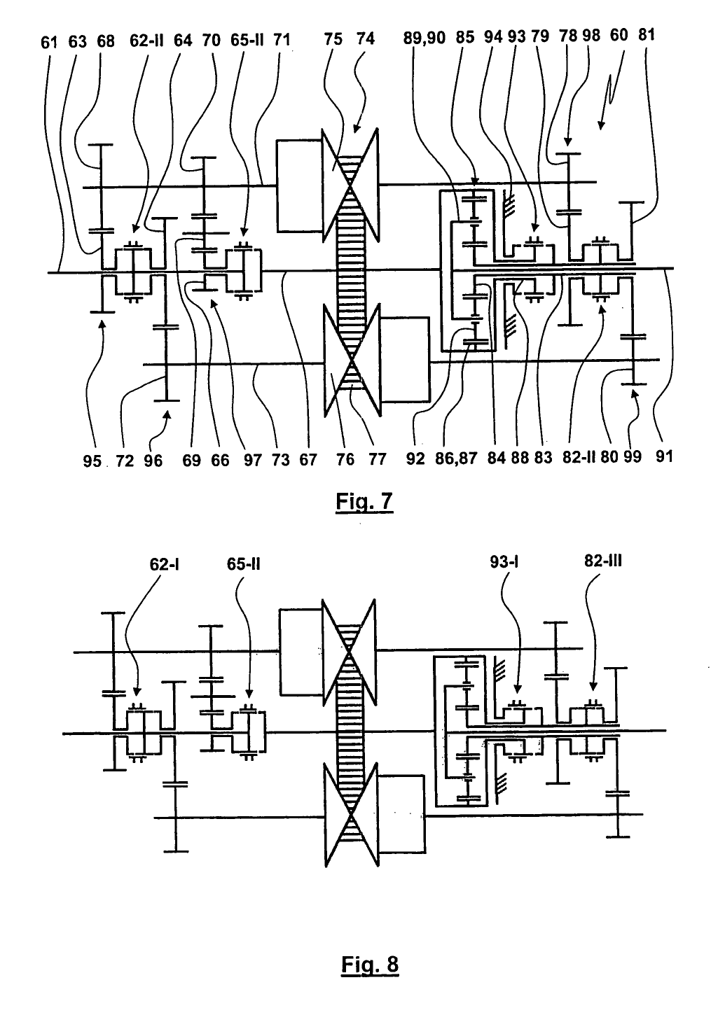

FIG. 7 shows a further transmission 60, in which a transmission input shaft 61 is connected via a shift element 62 to a driving gearwheel 63 in a left-hand shift position 62-I, to a driving gearwheel 64 in a right-hand shift position 62-III and to neither of the gearwheels 63, 64 in a middle shift position 62-II.

Furthermore, the transmission input shaft 61 is connected via a shift element 65 to a driving gearwheel 66 in a left-hand shift position 65-I, to a main shaft 67 in a right-hand shift position 65-III and neither to the driving gearwheel 66 nor to the main shift 67 in a middle shift position 65-II.

The driving gearwheel 63 meshes with a driven gearwheel 68, whilst the driving gearwheel 66 is drive-connected to a driven gearwheel 70 via a reverse-gear wheel 69, both the driven gearwheel 68 and the driven gearwheel 70 being connected fixedly in terms of rotation to a secondary shaft 71.

The driving gearwheel 64 meshes with a driven gearwheel 72 which is drive-connected to a secondary shaft 73. The secondary shafts 71, 73 are in a continuously variable step-up connection with disc sets 75, 76 and with a wrap-around means 77 via a wrap-around variator 74. On that side of the wrap-around variator 74 which lies opposite the transmission input shaft 61, the secondary shaft 71 carries a driving gearwheel 78 which meshes with a driven gearwheel 79. On that side of the wrap-around variator 74 which lies opposite the transmission input shaft 61, a secondary shaft 73 carries a driving gearwheel 80 which meshes with a driven gearwheel 81.

Via a shift element 82, the driven gearwheel 79 can be connected to a hollow shaft 83 in a left-hand shift position 82-I and the driven gearwheel 81 can be connected to the hollow shaft 83 in a right-hand shift position 82-III, the hollow shaft 83 carrying a sun wheel 84 in the end region facing the wrap-around variator 74.

In a planet set 85, a transmission element 86, here a ring wheel 87, is connected fixedly in terms of rotation to the main shaft 67 and to a hollow shaft 88 extending opposite the main shaft 67. A further transmission element 89, here a web 90, is connected fixedly in terms of rotation to a transmission output shaft 91. The sun wheel 84, web 90 and ring wheel 87 are coupled to one another via planets 92.

A shift element 93 connects a housing 94 to the hollow shaft 88 and consequently to the ring wheel 87 in a left-hand shift position 93-I, and the hollow shaft 88 to the hollow shaft 83 in a right-hand shift position 93-III, whilst, in the middle shift position 93-II, there is no connection between the housing 94, the hollow shaft 88 and the hollow shaft 83.

A step-up stage 95 is formed by the gearwheels 63, 68, a step-up stage 96 by the gearwheels 64, 72, a step-up stage 97 by the gearwheels 70, 69, 66, a step-up stage 98 by the gearwheels 78 and 79 and a step-up stage 99 by the gearwheels 80, 81. Starting from the input side of the transmission 60, the step-up stage 95, shift element 62, step-up stage 96, step-up stage 97, shift element 65, wrap-around variator 74, planet set 85, shift element 93, step-up stage 98 and step-up stage 99 are arranged in parallel planes lying one behind the other in the order mentioned.

FIG. 8 shows the transmission according to FIG. 7 in a first continuously variable drive range, in which no power split occurs and the planet set 85 forms a range group. The shift elements are in the shift positions 62-I, 65-II, 93-I, 82-III. A power flow takes place via the transmission input shaft 61, shift element 62, driving gearwheel 63, driven gearwheel 68, secondary shaft 71, disc set 75, wrap-around means 77, disc set 76, secondary shaft 73, driving gearwheel 80, driven gearwheel 81, shift element 82 and hollow shaft 83 to the sun wheel 84. A ring wheel 87 is braked with respect to the housing 94, so that there is a defined step-up via the planets 92 between the sun wheel 84 and the web 90 to the transmission output shaft 91.

For a second continuously variable drive range which is not power-split and in which the planet set 85 likewise takes effect as a range group, the shift elements are in shift positions 62-III, 65-II, 93-I and 82-I. The power flow runs via the transmission input shaft 62, shift element 62, driving gearwheel 64, driven gearwheel 72, secondary shaft 73, disc set 76, wrap-around means 77, disc set 75, secondary shaft 71, driving gearwheel 78, driven gearwheel 79, shift element 82 and hollow shaft 83 to the sun wheel 84, the ring wheel being braked with respect to the housing in the planet set 85 according to FIG. 8. For this drive range, the power flow is reversed, as compared with FIG. 8, via the wrap-around variator.

For a third continuously variable drive range which is power-split, the shift elements are in shift positions 62-I, 65-III, 93-II and 82-III. In this third drive range, the power is split to two power paths in the region of the shift element 62, the first power path running between the driving gearwheel 63 and the sun wheel 84 correspondingly to the first drive range. In the other power path, the power runs from the shift element 62, without gearwheel stages being interposed, via the shift element 65 to the main shaft 67 and drives the ring wheel 87 directly. In the planet set 85, a superposition of the two power paths takes place, which are fed, on the one hand, into the ring wheel 87 and, on the other hand, into the sun wheel 84, to the web 90 which, in turn, drives the transmission output shaft 91.

In a fourth possible power-split and continuously variable drive range, the shift elements are in shift positions 62-III, 65-III, 93-II and 82-I. For this drive range, correspondingly to the third drive range, a direct drive of the ring wheel 87 takes place in one power path, whilst, in the other power path, the power runs from the shift element 62 as far as the sun wheel 84 correspondingly to the second drive range. In this power-split drive range, too, a combining of the power branches takes place in the planet set 85 in the case of output via the web 90.

In a direct gear, the shift elements are in shift positions 62-II, 65-III, 93-III, 82-II. For the direct gear, a direct drive of the ring wheel 87 takes place, the planet set being blocked via shift position 93-III, thus resulting in high efficiency.

For a first continuously variable reverse drive range with no power split, the shift elements are in shift positions 62-II, 65-I, 93-I and 82-III. Accordingly, a power flow takes place via the transmission input shaft 61, shift element 65 and reverse-gear step-up stage 97 to the secondary shaft 71, the further power flow corresponding to the power flow according to FIG. 8.

For a second continuously variable reverse drive range with no power split, the shift elements are in shift positions 62-I, 65-I, 93-III and 82-III. The power flow corresponds essentially to the power flow for the first reverse drive range, although the planet set 85 is blocked as a result of shift position 93-III.

A reverse-gear stage with a fixed step-up, in which the wrap-around variator 74 does not lie in the power flow and the planet set 85 rotates in a block, is provided when the shift elements are in shift positions 62-II, 65-I, 93-III and 82-I. In this case, a power flow takes place via the transmission input shaft 61, shift element 65, reverse step-up stage 97, secondary shaft 71, driving gearwheel 78, driven gearwheel 79, shift element 82 and hollow shaft 83 to the blocked planet set 85.

Another gear stage for a reverse drive with a fixed step-up and an active range group is provided when the shift elements are in shift positions 62-II, 65-I, 93-I and 82-I. In this case, with the power flow otherwise corresponding essentially to the other reverse-gear stage with a fixed step-up, the planet set 85 is not blocked, but, instead, the sun wheel 84 is driven, whilst the ring wheel 87 is braked fixedly with respect to the housing.

For the power split, particularly in an individual drive range, cf. FIG. 4, in one power path, see FIG. 4 power path 47, there is a direct drive of a transmission element, cf FIG. 4 the sun wheel, with a step-up i=1, with the result that tooth engagement losses are avoided in this power path. The shift elements are positive and/or non-positive shift elements, for example sliding sleeves shiftable on both sides. The step-up ranges in the drive ranges may adjoin one another seemlessly. Alternatively, they may also have “step-up overlaps” in a controlled way, thus giving rise to a particular step-up range within which a change of the drive range can be carried out.

It is particularly advantageous if the transmission is designed in such a way that the change of a drive range takes place at what is known as a synchronous point so that, in principle, there is no need for any adjustment of the step-up of the wrap-around variator during the change of the drive range. Furthermore, for a change of the drive range at a synchronous point, there is no need for any rotational speed difference to be bridged within the shift elements. In practice, in terms of measurement and actuation inaccuracies, relatively low differential rotational speeds may occur.

Advantageously, the transmission is designed, for example, in the form of what is known as an i²-transmission.

It may alternatively be expedient, in the case of a change of the drive range, to deviate slightly in a controlled way from the theoretical synchronous state described above. This may be advantageous, for example, when dog toothings are used as shift elements. The situation can thereby be avoided where, during the changeover operation, a “tooth-on-tooth position” may occur which would impede or prevent the changeover operation.

Alternatively, the continuously variable transmission may be configured in such a way that a changeover operation between the drive ranges is always associated with a considerable adjustment in the step-up of the wrap-around variator. Irrespective of whether the changeover operation takes place at a synchronous point or not, it is possible, by controlled adjustment of a variator step-up, to ensure, during the changeover operation, that a specific rotational speed difference, which may, of course, also lie at zero or near to zero, is established on the shift elements involved in the changeover operation. In the event of a differential rotational speed near to zero, synchronization would therefore take place, as it were, by means of the adjustment of the wrap-around variator.

The reverse mode may, in principle, be executed in three ways. The transmission may operate with a power split even if in reverse mode (in which case, where appropriate, reactive powers arise which ensure that the loads on individual components, that is to say, for example, also on the variator, may be higher than without a power split). The transmission may also operate with no power split in reverse mode, that is to say the variator is acted upon, even in the reverse mode of the transmission, by the transmission input power, if appropriate minus the relevant power losses, for example Planck's losses and pump powers, etc. Reverse mode is implemented in that a reshift transmission contains a unit for implementing a reverse step-up, that is to say a reversal in direction of rotation.

Alternatively to the embodiments illustrated, a planet set may also be arranged on the input side, so that the latter is not used for combining the power paths, but, instead, for dividing the power paths.

The overall spread over the two drive ranges of the continuously variable transmission within the continuously variable power path is identical to the square of the spread of the variator for the embodiment as an i²-transmission. However, the overall spread of the split transmission structure is different from the square of the spread of the variator.

The transmissions illustrated may be hollowed, in order to broaden the spread, by a reshift transmission which is designed, for example, as a multi-stage transmission in a countershaft or planet type of construction. One of the gears of the reshift transmission may be a direct gear, so that no power transmission takes place by means of interposed gearwheels. The reshift transmission may contain a unit for reversing the direction of rotation for a reverse-drive mode.

The transmission structure has (without a unit for reversing the direction of rotation and without a reshift transmission) preferably four wheel planes and one planet set. However, the transmission may also be (without a unit for direction reversal) a transmission with 3 wheel planes and with one additional planet set.

In the event of a change of the power-split drive ranges, an input side of the wrap-around variator is operatively connected to a different transmission element of the planet set in one drive range from that in another power-split drive range. The part-spread of the individual drive ranges may be identical or different. Advantageously, the part-spread of that drive range which has the longest dwell time for conventional driving cycles should be smaller, since the lower power is then routed via the variator. This is, for example, a drive range with overdrive.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

I claim

1. A transmission for a motor vehicle, with at least two continuously variable drive ranges, in which a power split to two power paths takes place, comprising:
gear wheels,
a variator, and
a planet set,
wherein in one power path, power transmission via pairs of the gearwheels or directly takes place,
wherein in the other power path, power transmission takes place via the variator which allows a continuous change of step-up,
wherein the two power paths can be combined via the planet set,
wherein at least one further continuously variable drive range is provided, in which no power split takes place and in which the planet set is used as a range group, and
wherein a change from one power-split drive range to another power-split drive range takes place at a synchronous point.

2. The transmission according to claim 1, wherein a direction of power flow is reversed via the variator in the event of when a change from a first power-split drive range to a second power-split drive range occurs.

3. The transmission according to claim 2, wherein at least one shift element is interposed into the power path, running via the variator, of a first of the at least two continuously variable drive ranges, and into the power path, running via the variator, of a second of the at least two continuously variable drive ranges.

4. The transmission according to claim 3, wherein, in each power path running via the variator, the variator is preceded by a shift element and followed by a shift element.

5. The transmission according to claim 3, wherein, in the power path of the first of the continuously variable drive ranges, in the power path of the second of the continuously variable drive ranges, or in the power paths of both the first and second of the continuously variable drive ranges, the variator is preceded by, followed by, or both preceded by and followed by at least one step-up stage.

6. The transmission according to claim 1, wherein the power split takes place with one of the power paths running via a transmission element which is drive-connected to a shaft of one of the power paths and to a gearwheel of the other of the power paths.

7. The transmission according to claim 2, wherein step-ups of the first power-split drive range and of the second power-split drive range have an overlap.

8. The transmission according to claim 2, wherein step-ups of the first power-split drive range and of the second power-split drive range adjoin one another.

9. The transmission according to claim 2, wherein a control device varies the step-up of the variator in time proximity to a change between the first power-split drive range and the second power-split drive range so as to provide synchronization, adaptation, or both synchronization and adaptation of an angular position in the region of a shift element to be actuated.

10. The transmission according to claim 2, wherein a power-split reverse drive range is provided.

11. The transmission according to claim 1, wherein a reshift transmission is provided.

12. The transmission according to claim 11, wherein a direct gear is provided in the reshift transmission.

13. The transmission according to claim 11, wherein a direction reversal for a reverse gear or a reverse drive range takes place in the reshift transmission.

14. The transmission according to claim 1, wherein four wheel planes and one plane for the planet set are arranged axially one behind the other.

15. The transmission according to claim 1, wherein the planet set serves for combining the power branches, wherein, in a drive range with no power split, a transmission element of the planet set is shiftable fixedly with respect to a housing via a brake, and wherein, when the transmission element is shifted fixedly with respect to the housing, the planet set forms a range group.

16. The transmission according to claim 1, wherein the variator is designed as a wrap-around variator.

17. The transmission according to claim 4, wherein, in the power path of the first of the continuously variable drive ranges, in the power path of the second of the continuously variable drive ranges, or in the power paths of both the first and second of the continuously variable drive ranges, the variator is preceded by, followed by, or both preceded by and followed by at least one step-up stage.

18. The transmission according to claim 2, wherein the power split takes place with one of the power paths running via a transmission element which is drive-connected to a shaft of one of the power paths and to a gearwheel of the other of the power paths.

19. The transmission according to claim 3, wherein the power split takes place with one of the power paths running via a transmission element which is drive-connected to a shaft of one of the power paths and to a gearwheel of the other of the power paths.

20. The transmission according to claim 4, wherein the power split takes place with one of the power paths running via a transmission element which is drive-connected to a shaft of one of the power paths and to a gearwheel of the other of the power paths.
